(19) United States
(12) Patent Application Publication
(10) Pub. No.: US 2020/0201696 A1
(43) Pub. Date: Jun. 25, 2020

(54) SYSTEM AND METHOD FOR BACKUP FAILURE PREVENTION IN DEDUPLICATION-BASED STORAGE SYSTEM

(71) Applicant: EMC IP Holding Company LLC, Hopkinton, MA (US)

(72) Inventors: Rahul Deo Vishwakarma, Bangalore (IN); Jayanth Kumar Reddy Perneti, Bangalore (IN); Nupur Gupta, Bangalore (IN)

(21) Appl. No.: 16/231,237

(22) Filed: Dec. 21, 2018

(51) Int. Cl. G06F 11/00; G06F 11/34; G06F 11/07; H04L 29/08

(52) U.S. Cl. CPC G06F 11/008; G06F 11/3442; G06F 11/3419; G06F 11/3034; G06F 11/0727; H04L 67/1097; G06F 11/0793

(57) ABSTRACT

A data storage for storing client data includes a persistent storage and a storage manager. The persistent storage stores a deduplicated client data repository. The storage manager generates a time series of the deduplicated client data repository; predicts a future available storage capacity of the deduplicated client data repository using a two factor higher order fuzzy time forecasting module, and the time series; makes a determination that a storage failure of the deduplicated client data repository will occur based on the future available storage capacity; and performs a remediation of the storage failure in response to the determination.

### BACKGROUND

Computing devices may store information. The information may reflect information entered by a user. Such information may be important to a user.

For example, a user may type information into a database, may add data to a spreadsheet, or may draft emails. Each of these interactions between a user and a computing device may cause information important to a user to be stored in a computing device.

In a distributed computing environment, multiple computing devices may be operably connected to each other. To provide redundancy, copies of data may be stored in multiple computing devices to prevent failure of one of the computing devices from causing data loss.

### SUMMARY

In one aspect, a data storage for storing client data in accordance with one or more embodiments of the invention includes a persistent storage and a storage manager. The persistent storage stores a deduplicated client data repository. The storage manager generates a time series of the deduplicated client data repository; predicts a future available storage capacity of the deduplicated client data repository using a two factor higher order fuzzy time forecasting module, and the time series; makes a determination that a storage failure of the deduplicated client data repository will occur based on the future available storage capacity; and performs a remediation of the storage failure in response to the determination.

In one aspect, a method for managing client data stored in a deduplicated client data repository in accordance with one or more embodiments of the invention includes generating a time series of the deduplicated client data repository; predicting a future available storage capacity of the deduplicated client data repository using a two factor higher order fuzzy time forecasting module, and the time series; making a determination that a storage failure of the deduplicated client data repository will occur based on the future available storage capacity; and performing a remediation of the storage failure in response to the determination.

In one aspect, a non-transitory computer readable medium in accordance with one or more embodiments of the invention includes computer readable program code, which when executed by a computer processor enables the computer processor to perform a method for managing client data stored in a deduplicated client data repository. The method includes generating a time series of the deduplicated client data repository; predicting a future available storage capacity of the deduplicated client data repository using a two factor higher order fuzzy time forecasting module, and the time series; making a determination that a storage failure of the deduplicated client data repository will occur based on the future available storage capacity; and performing a remediation of the storage failure in response to the determination.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a diagram of a system in accordance with one or more embodiments of the invention.

FIG. 1.2 shows a diagram of a backup storage in accordance with one or more embodiments of the invention.

FIG. 2.1 shows a flowchart of a method of managing client data in accordance with one or more embodiments of the invention.

FIG. 2.2 shows a flowchart of a method of generating a storage capacity forecast in accordance with one or more embodiments of the invention.

FIG. 2.3 shows a flowchart of a method of modifying a storage management workflow in accordance with one or more embodiments of the invention.

FIG. 3.1 shows a diagram of an example system at a first point in time.

FIG. 3.2 shows an example time series diagram based on the example system of FIG. 3.1.

FIG. 3.3 shows an example forecast superimposed on the time series diagram of FIG. 3.2.

FIG. 3.4 shows an example updated forecast superimposed on the time series diagram of FIG. 3.2.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to systems devices and methods for providing data storage services to clients. A system in accordance with embodiments of the invention may include a backup storage that provides data storage services to any number of clients. The backup storage may include a finite amount of storage resources storing client data. To maximize the use of these finite storage resources, the system may be duplicate data before storing the client data.

In one or more embodiments of the invention, the backup storage forecasts its availability of storage resources. If the forecast indicates that the availability storage resources may be insufficient for future data storage services, the backup storage may take remedial action. By taking remedial action, the backup storage may improve the likelihood that sufficient storage resources will be available for storing client data.

In one or more embodiments of the invention, forecasts are generated using a multivariable forecasting model. The multivariable forecasting model may generate forecasts based on the historical availability of storage resources and deduplication ratio of previously stored client data. In one or more embodiments of the invention, the multivariable forecasting model is a fuzzy time series. The fuzzy time series may be a multi factor higher order fuzzy time series. In one or more embodiments of the invention, the multivariable forecasting model is a two factor higher order fuzzy time series.

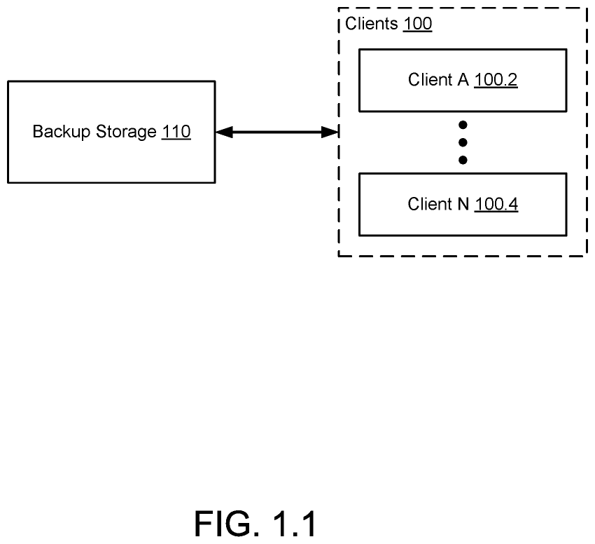

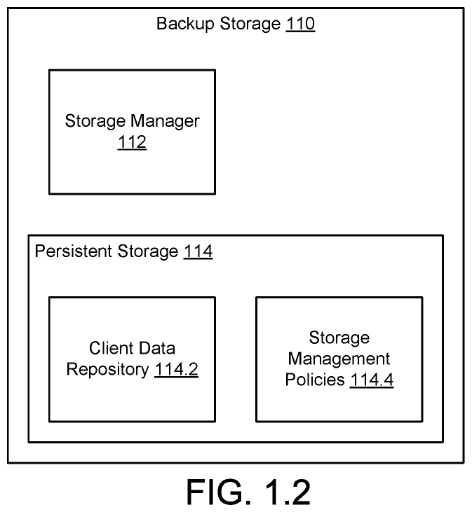

FIG. 1 shows an example system in accordance with one or more embodiments of the invention. The system may include clients (100) that obtain data storage services from the backup storage (110). The data storage services may include storage of backup data from the clients. The backup data may be usable to restore a state of a client to a prior state.

For example, the backup data may be an image of the client's stored data at a predetermined point in time. When stored in the backup storage (110), the image of the client's stored data may survive storage failure of the client. After failure, the client may retrieve the image of the client's stored data to restore the client to the state of the client when the image of the client's data was generated.

While described with respect to an image of the client's stored data, other types of backups and/or other types of data may be stored by the clients (100) in the backup storage (110) without departing from the invention. For example, the clients (100) may use the backup storage (110) or remote storage rather than as a backup storage.

The backup storage (110) may provide data storage services to any number of clients. For example, the backup storage (110) may provide data storage services to a single client (100.2) or to multiple clients (e.g., 100.2, 100.4).

Each component of the system of FIG. 1 may be operably connected via any combination of wired and wireless connections. Each component of the system of FIG. 1 is discussed below.

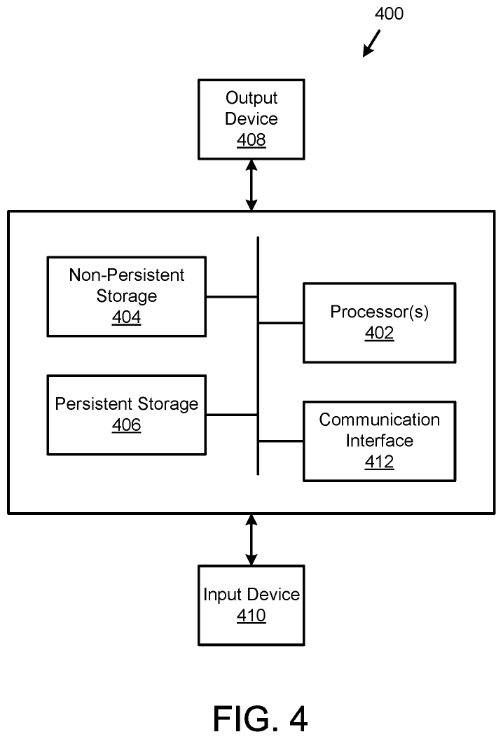

The clients (100) may be computing devices. The computing devices may be, for example, mobile phones, tablet computers, laptop computers, desktop computers, servers, or cloud resources. The computing devices may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions described in this application. The clients (100) may be other types of computing devices without departing from the invention. For additional details regarding computing devices, refer to FIG. 4.

The clients (100) may store data in backup storage (110). As noted above, the clients (100) may store data for backup purposes or for other purposes without departing from the invention. The clients (100) may use data stored in the backup storage (110) for restoration purposes or for other purposes.

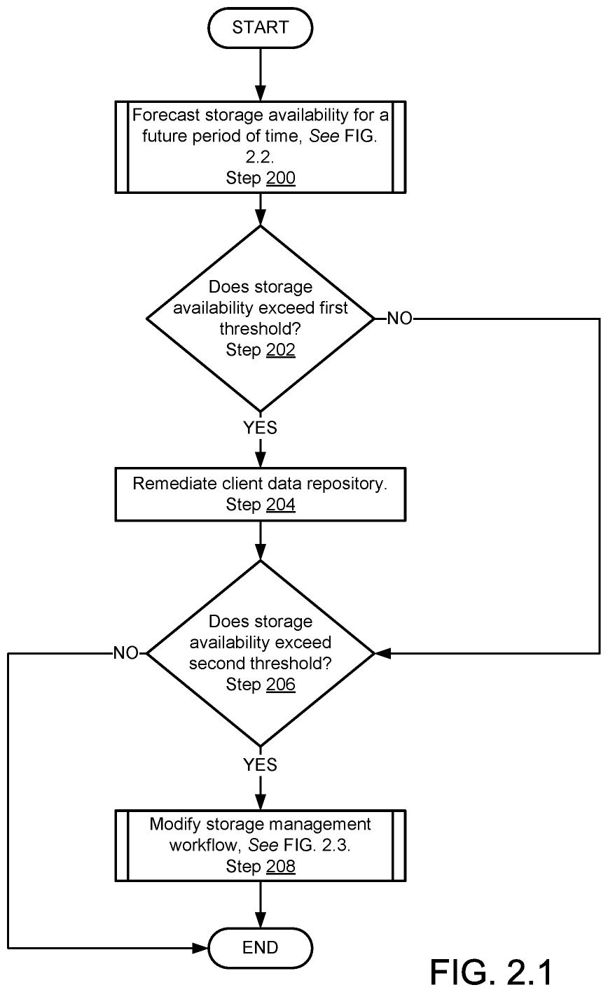

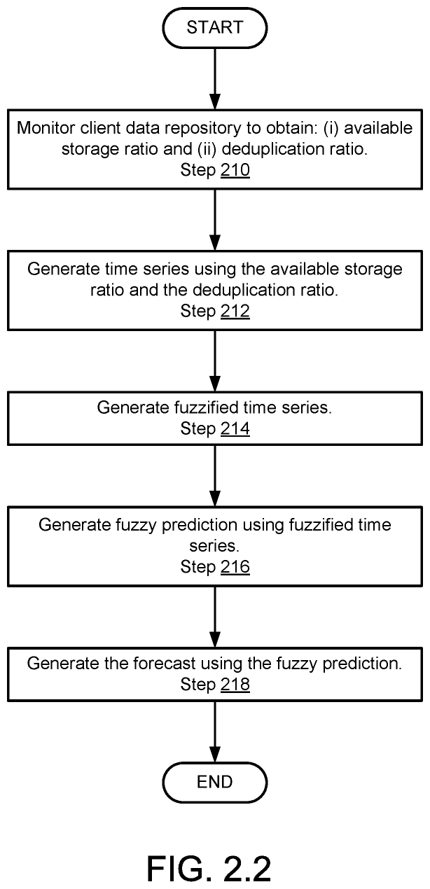

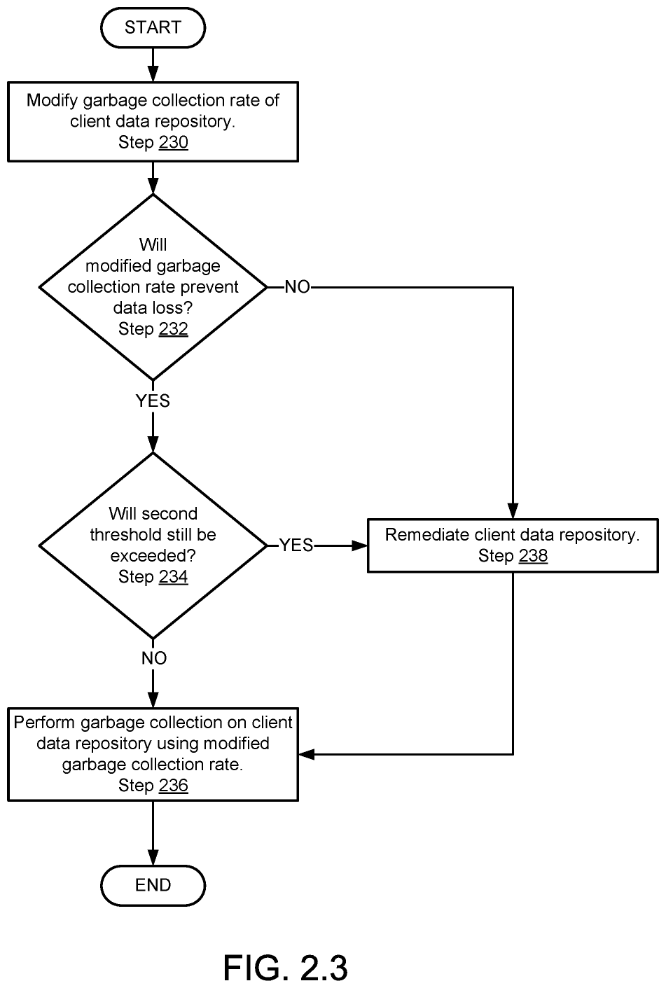

In one or more embodiments of the invention, the backup storage (110) is a computing device. A computing device may be, for example, a mobile phone, tablet computer, laptop computer, desktop computer, server, distributed computing system, or a cloud resource. The computing device may include one or more processors, memory (e.g., random access memory), and persistent storage (e.g., disk drives, solid state drives, etc.). The persistent storage may store computer instructions, e.g., computer code, that when executed by the processor(s) of the computing device that cause the computing device to provide the functionality of the backup storage (110) described through this application and all, or a portion, of the methods illustrated in FIGS. 2.1-2.3. For additional details regarding computing devices, refer to FIG. 4.

In one or more embodiments of the invention, the backup storage (110) is a distributed computing device. As used herein, a distributed computing device refers to functionality provided by a logical device that utilizes the computing resources of one or more separate and/or distinct computing devices. For example, in one or more embodiments of the invention, the backup storage (110) may be a distributed device that includes components distributed across any number of separate and/or distinct computing devices. In such a scenario, the functionality of the backup storage (110) may be performed by multiple different physical computing devices without departing from the invention.

In one or more embodiments of the invention, the backup storage (110) provides data storage services to the clients (100). To provide data storage services to the clients (100), the backup storage (110) may continuously monitor its storage capacity and may take proactive action in the event that that backup storage (110) does not have sufficient storage capacity in the future to store the client data. The proactive action may include modifying the management of previously stored client data in the backup storage (110) to more efficiently use the existing storage resources of the backup storage (110) and/or take remedial action to prevent a data storage failure caused by insufficient storage resources for storing client data. For additional details regarding the backup storage (110), refer to FIG. 1.2.

As discussed above, the backup storage (110) may provide data storage services to the clients (100). FIG. 1.2 shows a diagram of the backup storage (110) in accordance with one or more embodiments of the invention.

As noted above, the backup storage (110) may provide data storage services to clients. To provide storage services to the clients, the backup storage (110) may include a storage manager (112) and a persistent storage (114). Each component of the backup storage (110) is discussed below.

In one or more embodiments of the invention, the storage manager (112) manages stored client data in the backup storage (110). To manage the stored client data, the storage manager (112) may: (i) perform garbage collection on previously stored client data to remove client data that is no longer relevant thereby freeing storage resources for storing client data, (ii) monitor the storage resources of the backup storage (110), (iii) forecast future storage capacity for storing client data based on the monitoring, and/or (iv) take action in the event that forecasted future storage capacity for storing client data indicates that the storage failure may occur. The storage failure may occur when the backup storage (110) does not have sufficient storage resources for storing client data.

For example, the backup storage (110) may only have a storage capacity of 10 TB. As clients stored data in the backup storage (110), the backup storage (110) may run out of storage capacity for storing the client data. If clients attempt to store data in the backup storage (110) after the backup storage (110) runs out of storage capacity for storing the client data, the backup storage (110) may not be able to provide data storage services to the clients. Consequently, the clients may be unable to store data in the backup storage (110) leaving the clients susceptible to data loss.

To prevent a scenario in which a data storage failure may occur, the backup storage (110) may proactively forecast its ability to store client data in the future and may take remedial action in the event that a forecast indicates that the storage failure may occur. In one or more embodiments of the invention, the backup storage (110) performs forecasting using a multivariable prediction model. The multivariable prediction model may generate forecasts based on the available storage resources of the backup storage (110) and a deduplication ratio for stored client data. The multivariable prediction model may use a time series of the aforementioned parameters over a predetermined period of time in the past and generate a forecast of the availability of storage resources of the backup storage (110) over a predetermined duration of time in the future.

In one or more embodiments of the invention, the multivariable prediction model is a two factor higher order fuzzy time series forecasting model. To generate a forecast using the two factor higher order fuzzy time series forecasting model, the following steps may be performed: (i) a time series, over a predetermined period of time in the past, of the available storage resources of the backup storage and the duplication ratio of client data is generated, (ii) the time series is partitioned using a re-partitioning discretization approach to obtained a partitioned time series, (iii) linguistic terms for both the available storage resources of the backup storage and the de-duplication ratio of client data are generated, (iv) the partitioned time series is fuzzified using the linguistic terms to obtain a fuzzified time series, (v) a fuzzy logic relationship is generated based on the was applied time series, (vi) a fuzzy logic relationship group is generated based on the fuzzy logic relationship, (viii) the fuzzy logic relationship group is defuzzified to obtain a forecast model, and (ix) the forecast is generated for a predetermined time in the future using the forecast model. In one or more embodiments of the invention, the time series is a two-variable time series. A first variable of the two-variable time series may be a deduplication rate, e.g., deduplication ratio, of a storage. The second variable of the two-variable time series may be a capacity ratio, e.g., a ratio of unused capacity to total capacity of the storage. Both variables of the two-variable time series may be over a predetermined period of time.

In one or more embodiments of the invention, the re-partitioning discretization approach for partitioning the time series is performed by breaking each factor (e.g., available resources, deduplication ratio) entity boundaries based on the midpoint calculated from a universe of discourse operator. The regions defined by the entity boundaries may be separately partitioned into intervals. That is, the intervals for the available resources in the intervals for the de-duplication ratio may be different. Only intervals that have corresponding elements may be used for forecasting purposes. By doing so, the total number of intervals may be reduced thereby reducing the computational cost for forecasting when compared to contemporary prediction models that may take into account all intervals.

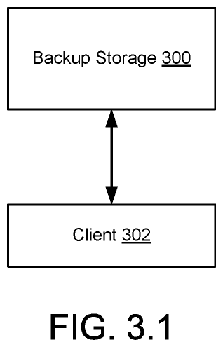

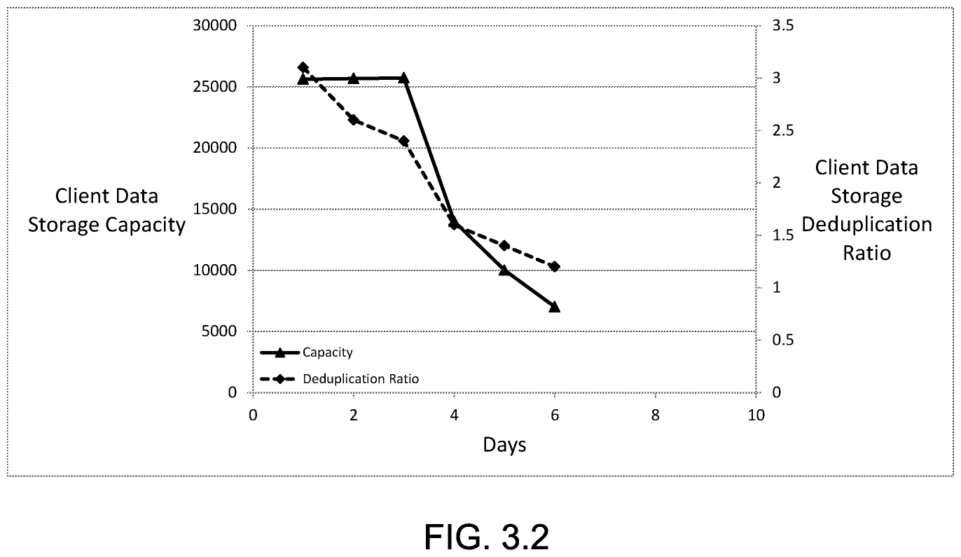

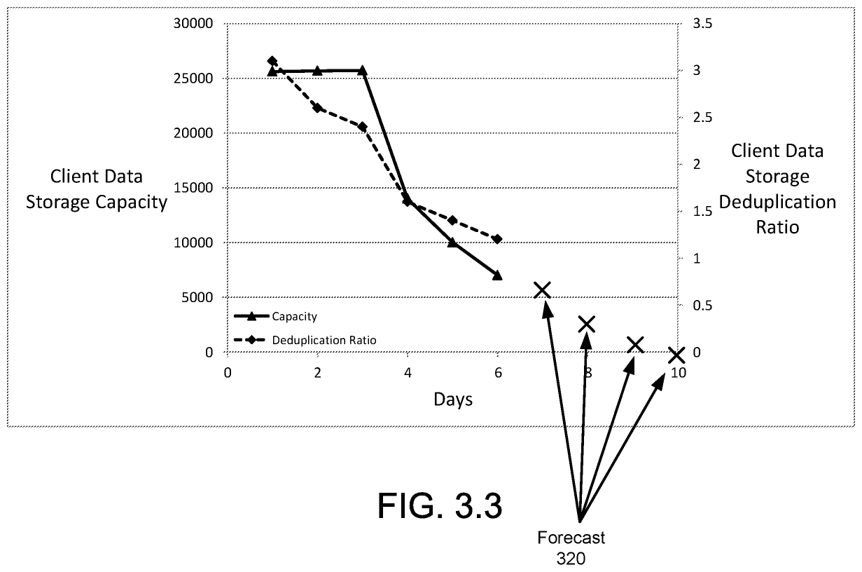

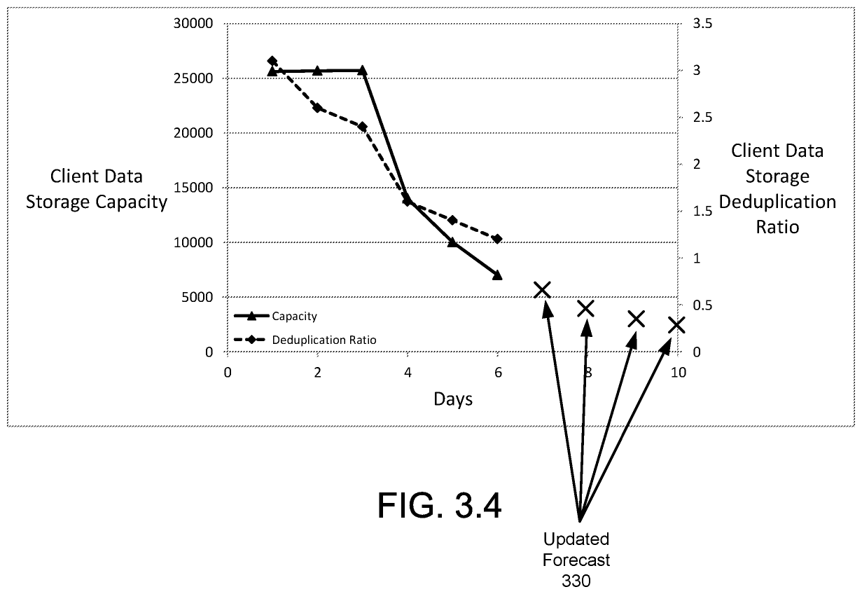

To provide the above-noted functionality of the storage manager (112), the storage manager (112) may perform all or portion of the methods illustrated in FIGS. 2.1-2.3. For a detailed example of generating a forecast, refer to FIGS. 3.1-3.4.

In one or more embodiments of the invention, the storage manager (112) is a hardware device including circuitry. The storage manager (112) may be, for example, a digital signal processor, a field programmable gate array, or an application specific integrated circuit. The storage manager (112) may be other types of hardware devices without departing from the invention.

In one or more embodiments of the invention, the storage manager (112) is implemented as computing code stored on a persistent storage that when executed by a processor performs the functionality of the storage manager (112). The processor may be a hardware processor including circuitry such as, for example, a central processing unit or a microcontroller. The processor may be other types of hardware devices for processing digital information without departing from the invention.

In one or more embodiments of the invention, the persistent storage (114) is a storage device that stores data structures. The persistent storage (114) may be a physical or logical device. For example, the persistent storage (114) may include solid state drives, solid state drives, tape drives, and other components to provide data storage functionality. Alternatively, the persistent storage (114) may be a logical device that utilizes the physical computing resources of other components to provide data storage functionality.

In one or more embodiments of the invention, the persistent storage (114) stores a client data repository (114.2) and storage management policies (114.4). Each of these data structures is discussed below.

The client data repository (114.2) may be a data structure that stores client data. The storage manager (112) may receive data from the clients for storage and store the received client data in the client data repository (114.2). The client data repository (114.2) may store any quantity of client data without departing for from the invention. However, the quantity of client data storable in the client data repository (114.2) may be limited by the storage capacity of the persistent storage (114).

In one or more embodiments of the invention, the client data repository (114.2) is a de-duplicated data storage repository. A duplicated data storage repository may be a repository in which only a single copy of any portion of data is stored. For example, when a portion of client data is received for storage in the client data repository (114.2), a portion of client data may be compared to already stored data in the client data repository (114.2). If the portion of client data is duplicative of the already stored data in the client repository (114.2), the portion of the client data may not be stored. Rather, an association between the client that attempted to store the client data and the already stored data in the client repository (114.2) may be generated. By doing so, the total quantity of client data that is effectively stored in the client data repository (114.2) may be increased when compared to storing data in a repository that is not deduplicated.

In one or more embodiments of the invention, a deduplication ratio is a ratio between the amount of data that is received for storage divided by the amount of data that is actually stored. The deduplication ratio may be temporal. That is, the deduplication ratio may be associated with predetermined periods of time. For example, a deduplication may be calculated on a daily basis to form a time series of deduplication ratios. In such a scenario, a deduplication ratio may be calculated for a first day, a second day, a third day, etc.

In one or more embodiments of the invention, a deduplication ratio is a ratio of the effective storage capacity of a deduplicated storage repository to the actual storage capacity of the deduplicated storage repository. In other words, the quantity of effective storage divided by the quantity of actual storage.

In one or more embodiments of the invention, the client data repository (114.2) is not perfectly duplicated. For example, an imperfect deduplicator may be used. An imperfect deduplicator may not identify all portions of data that are duplicative of previously stored data. Performing deduplication may be computationally expensive process. To reduce the cost of performing de-duplication, imperfect deduplication may be employed.

In one or more embodiments of the invention, deduplication may be performed by dividing client data into any number of segments and deduplicating the segments against segments already stored in the client data repository (114.2). A data structure specifying the segments required to reconstitute the client data may be generated and stored in the persistent storage (114).

The storage management policies (114.4) may be a data structure that includes policies for managing client data. The storage management policies (114.4) may specify when and under what conditions the storage manager (112) is to take action in response to forecasts regarding the storage capacity of the backup storage (110) for storing client data.

In one or more embodiments of the invention, the storage management policies (114.4) specify a number of thresholds. Each of the thresholds may specify an availability of storage capacity of the backup storage (110). Each of the thresholds may be associated with a corresponding action to be performed by the storage manager (112) when the associated threshold is reached.

For example, the storage management policies (114.4) may include a first threshold that specifies an 80% utilization rate of the storage resources of the backup storage (110) and a second threshold that specifies an 85% utilization rate of the storage resources the backup storage (110). The first threshold may be associated with an action that indicates that additional computing resources of the backup storage (110) are to be dedicated for garbage collection. The second threshold may be associated with a second action that indicates that an administrator is to be notified of a potential data storage failure.

The storage management policies (114.4) may include any number of thresholds with any number of associated actions without departing from the invention.

While the persistent storage (114) illustrated in FIG. 1.2 is shown as including a limited number of data structures, the persistent storage (114) may include additional, fewer, and/or different data structures without departing from the invention. Further, while the data structures are illustrated as being separate, the data included in the data structures (114.2, 114.4) may be stored as a single data structure, may include additional information than that discussed above, and may be stored in different locations without departing from the invention.

As discussed above, components of the system of FIG. 1.1 may perform methods for providing data storage services. FIGS. 2.1-2.3 show methods in accordance with one or more embodiments of the invention that may be performed by components of the system of FIG. 1.1. Any of the steps show in FIGS. 2.1-2.3 may be omitted, performed in a different order, and/or performed in parallel or partially overlapping manner with respect to other steps without departing from the invention.

FIG. 2.1 shows a flowchart of a method in accordance with one or more embodiments of the invention. The method depicted in FIG. 2.1 may be used to manage a data repository for providing data storage services in accordance with one or more embodiments of the invention. The method shown in FIG. 2.1 may be performed by, for example, a backup storage (e.g., 110, FIG. 1.1). Other components of the system illustrated in FIG. 1.1 may perform the method of FIG. 2.1 without departing from the invention.

In step 200, a storage availability for future period of time is forecasted.

In one or more embodiments of the invention, the future period of time is multiple days. For example, the future period of time may be seven days. The future period of time may have other durations without departing from the invention.

In one or more embodiments of the invention, the storage availability is the availability of storage for storing client data. For example, as described with respect to FIG. 1.2, a backup storage may have a limited capacity for storing client data.

In one or more embodiments of the invention, the forecast of the storage availability is a prediction of the available storage for storing client data. These forecasts may be used to determine whether or not storage failure is likely to occur. The storage failure may be the inability of a backup storage to store all of the client data requested to be stored by the clients.

In one or more embodiments of the invention, the forecast is generated via the method illustrated in FIG. 2.2. Forecast may be generated via other methods without departing from the invention.

In step 202, it is determined whether the storage availability exceeds a first threshold. As noted with respect to FIG. 1.2, management policies may specify any number of thresholds associated with actions to be performed in response to the thresholds being met.

For example, if the forecasted storage availability indicates that 83% of the available storage resources will be utilized at a future point in time and the first threshold is 80%, the first threshold may be exceeded. Thresholds may define any type of test for determining whether the storage availability exceeds the threshold without departing from the invention.

If the storage availability exceeds the first threshold, the method may proceed to step 204. If the storage availability does not exceed the first threshold, the method may proceed to step 206.

In step 204, a client data repository for which the forecast of Step 200 was generated is remediated.

In one or more embodiments of the invention, the client data repository is remediated based on an action associated with the first threshold.

In one or more embodiments of the invention, the action is to send a notification to an administrator that indicates that a storage failure is likely to occur.

In one or more embodiments of the invention, the action is to add additional storage capacity to the client data repository.

In step 206, it is determined whether the storage availability exceeds a second threshold.

In one or more embodiments of the invention, the second threshold is different from the first threshold. For example, the second threshold may be larger than the first threshold. Alternatively, the second threshold may be smaller than the first threshold.

In one or more embodiments of the invention, the determination is a prediction.

For example, when making the determination, the forecast of Step 200 may be utilized as a basis upon which the determination is made. In this manner, the determination may be speculative because it is based on a forecast, i.e., a prediction, rather than historical facts.

If the storage availability exceeds the second threshold, the method may proceed to step 208. If the storage availability does not exceed the second threshold, the method may end following step 206.

In step 208, storage management workflows modified.

In one or more embodiments of the invention, the storage management workflow is a workflow for performing garbage collection. As noted above, performing garbage collection may improve the availability of storage for storing client data.

In one or more embodiments of the invention, the storage management workflow is modified via the of the method illustrated in FIG. 2.3. The storage management workflow may be modified via other methods without departing from the invention.

The method may end following step 208.

FIG. 2.2 shows a flowchart of a method in accordance with one or more embodiments of the invention. The method depicted in FIG. 2.2 may be used to forecast storage availability in accordance with one or more embodiments of the invention. The method shown in FIG. 2.2 may be performed by, for example, a backup storage (e.g., 110, FIG. 1.1). Other components of the system illustrated in FIG. 1.1 may perform the method of FIG. 2.2 without departing from the invention.

In step 210, a client data repository is monitored to obtain (i) and available storage ratio and (ii) a deduplication ratio.

In one or more embodiments of the invention, the available storage ratio indicates the amount of available storage in a client data repository.

In one or more embodiments of the invention, the deduplication ratio indicates a rate of the deduplication of data being stored in the client data repository.

In one or more embodiments of the invention, the client data repository is monitored over a predetermined period of time. The predetermined period of time may be, for example, the number of days. The number of days may be, for example, five days. The predetermined period of time may be of other durations without departing from the invention.

In one or more embodiments of the invention, the predetermined period of time is proportional to a second period of time in the future for which forecast will be generated. The second period of time in the future may be of different durations that a predetermined period of time without departing from the invention.

In step 212, a time series is generated using the available storage ratio and/or the data duplication ratio.

In one or more embodiments of the invention, the time series is relationship between each of these ratios during the predetermined period of time. For example, the time series may specify the available storage ratio entity duplication ratio for each day during the predetermined period of time. The time series may be specified with different degrees of granularity without departing from the invention. For example, the time series may be specified with time increments of portions of days or on an hourly basis.

In step 214, the time series is fuzzified to generate a fuzzified time series.

In one or more embodiments of the invention, the time series is fuzzified by separately partitioning the time series into intervals separately for each of the available storage ratios and the deduplication ratios via the re-partitioning discretization approach. Linguistic terms for available storage ratio and the deduplication ratio may be selected and used to fuzzify the intervals to obtain the fuzzified time series.

In step 216, a fuzzy prediction is generated using the fuzzified time series.

In one or more embodiments of the invention, the fuzzy prediction is generated by generating fuzzy logic relations using the fuzzified time series. The fuzzy logic relations may be used to generate a fuzzy logic relation group to generate a fuzzy prediction.

In Step 218, a forecast is generated using the fuzzy prediction.

In one or more embodiments of the invention, the forecast is generated by defuzzifying the fuzzy logical relationship group to obtain a forecasting model. The forecasting model may be used to generate the forecast.

For example, the forecast model may predict the availability of storage of the backup storage for a predetermined period of time in the future.

The method may end following Step 218.

FIG. 2.3 shows a flowchart of a method in accordance with one or more embodiments of the invention. The method depicted in FIG. 2.3 may be used to modify a storage management workflow in accordance with one or more embodiments of the invention. The method shown in FIG. 2.3 may be performed by, for example, a backup storage (e.g., 110, FIG. 1.1). Other components of the system illustrated in FIG. 1.1 may perform the method of FIG. 2.3 without departing from the invention.

In step 230, the garbage collection rate of the client data repository is modified.

In one or more embodiments of the invention, the garbage collection rate is modified by allocating additional computing resources for performing garbage collection of client data repository. Allocating additional computing resources to perform garbage collection of the client data repository may increase a rate at which storage capacity of the client data repository is recovered by deleting client data in the client data repository that is no longer necessary for providing data storage services to clients.

The garbage collection rate may be modified via other methods without departing from the invention. For example, the garbage collection rate may be modified by time shifting periods of time during which garbage collection is performed (in contrast with other periods of time during which garbage collection is not performed). The time shifting may cause the periods of time during which garbage collection to be performed to be before a point in time at which a predicted storage failure will occur. Doing so may reduce the likelihood of the storage failure from actually occurring by freeing data storage capacity that may avert the storage failure.

In step 232, it is determined whether the modified garbage collection rate will prevent data loss from occurring.

In one or more embodiments of the invention, the determination is made by comparing a rate of storage capacity recovery due to the modified garbage collection rate to a forecasted storage availability. For example, by increasing the storage capacity recovery rate, the data loss predicted by the forecast may not occur. The determination may be made by determining when the data loss is predicted to occur, determining necessary quantity of storage capacity must be recovered to avert the data loss, and comparing the quantity of storage capacity that will be covered by when the data loss is predicted to occur to the necessary quantity of storage capacity the must be recovered to avert the data loss.

If it is determined that the modified garbage collection rate will prevent the data loss from occurring, the method may proceed to step 234. If it is determined that the modified garbage collection rate will not prevent the data loss from occurring, the method may proceed to step 238.

In step 234, it is determined whether the second threshold of step 206 of FIG. 2.1 will be exceeded. That is, it is determined whether the increased rate of storage capacity recovery will reduce the forecasted storage availability to a level that does not exceed the second threshold.

If the second threshold will not be exceeded, the method may proceed to step 236.

If the second threshold will still be exceeded, the method may proceed to step 238.

In step 236, garbage collection is performed on the client data repository using the modified garbage collection rate. The method may end following step 236.

In step 238, which may be performed following step 232 or 238, the client data repository is remediated.

In one or more embodiments of the invention, the client data repository is remediated by notifying an administrator. The notification to the administrator may indicate that data loss is likely to occur because of insufficient storage capacity for storing client data.

In one or more embodiments of the invention, the notification may be sent with an alert level that is proportional to the threat of data loss. For example, if the data loss is likely to occur soon, the notification may be sent with a high level of importance. In contrast, if the data loss is likely to occur at a point in time long into the future, the notification may be sent with a low level of importance.

The method may proceed to step 236 following step 238.

Via the methods illustrated in FIGS. 2.1-2.3, a system in accordance with embodiments of the invention may reduce the likelihood of data loss of client data due to insufficient storage capacity for storing client data. In contrast to contemporary methods, the system may forecast such data loss with a high degree of accuracy and may automatically take action to remediate such forecasted data loss events.

To further clarify embodiments of the invention, a non-limiting example is provided in FIGS. 3.1-3.4. FIG. 3.1 illustrates a system similar to that of FIG. 1.1. For the sake of brevity, only a limited number of components of the system of FIG. 1.1 are illustrated in FIG. 3.1.

### EXAMPLE

Consider a scenario as illustrated in FIG. 3.1 in which a backup storage (300) provides data storage services to a client (302). The client (302) may store data in the backup storage (300) for backup purposes.

The backup storage (300) has a storage management policy that specifies a threshold of 2500 GB availability capacity and an action of notifying an administrator.

To provide data storage services to the client (302), the backup storage (300) performs the methods illustrated in FIGS. 2.1-2.3. Specifically, the backup storage (300) generates a time series as illustrated in FIG. 3.2.

FIG. 3.2 shows a diagram of a time series of both the storage capacity and de-ratio of stored client data by the backup storage (300) over a period of six days. In FIG. 3.2, the horizontal axes indicates the day, the left vertical axes indicates the client data storage capacity (in GB), and the right vertical axes indicates the client data storage deduplication ratio (unit less). In the diagram, the dashed line (with diamond markers) indicates the deduplication ratio and the solid line (with triangle markers) indicates the storage capacity.

Using the time series shown in FIG. 3.3, the backup storage (300) generates a forecast for the storage capacity of the backup storage (300) for a period of four days into the future to determine whether there is a threat of potential data loss in the next four days.

FIG. 3.3 shows the diagram of FIG. 3.2 with the generated forecast (320) superimposed on the time series. As seen in FIG. 3.3, the forecast (320) indicates that at day 10 the available storage capacity is likely to be 0 indicating that data loss may occur on day 10, four days in the future.

In response to determining that the data loss may occur, the backup storage (300) allocates additional resources for performing garbage collection. Based on the additional resources for performing garbage collection, an updated forecast 330 is generated as illustrated in FIG. 3.4. As seen from FIG. 3.4, the updated forecast indicates that on day 10 an available storage capacity of 2400 GB is likely to be present which indicates that data loss is not likely to occur due to insufficient storage resources. However, even with the reduced threat of data loss, the forecasted storage capacity at day 10 still exceeds the threshold of 2500 GB.

Because the threshold of the data management policy is exceeded, the backup storage sends a notification to an administrator indicating that there is still some possibility of data less.

End of Example

Any of the components of FIG. 1.1 may be implemented as distributed computing devices. As used herein, a distributed computing device refers to functionality provided by a logical device that utilizes the computing resources of one or more separate and/or distinct computing devices. As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

One or more embodiments of the invention may improve the field of distributed computation. Specifically, embodiments of the invention may improve the reliability of storing data in a distributed environment. Embodiments of the invention may improve the reliability for storing data in a distributed environment by improving the likelihood that redundant copies of the data are stored in multiple locations within the distributed environment. For example, embodiments of the invention may automatically monitor the availability of backup storage for storing client data, generate forecasts for the future storage capacity of the backup storage for storing client data, and automatically take remedial action in the event that a forecast indicates that data loss is likely to occur. By doing so, embodiments of the invention may reduce the likelihood of data loss in a distributed computing environment.

Thus, embodiments of the invention may address the problem that arises due to the technological nature of distributed computing environments. For example, distributed computing environments may rely on redundancy of data storage for data integrity purposes rather than highly reliable individual storages. Embodiments of the invention may improve such technological environments by improving the likelihood that storage capacity for redundant storage is available. In contrast, contemporary distributed computing systems may lose data because of the inability to predict future storage capacity needs for redundant data storage purposes.

The problems discussed above should be understood as being examples of problems solved by embodiments of the invention disclosed herein and the invention should not be limited to solving the same/similar problems. The disclosed invention is broadly applicable to address a range of problems beyond those discussed herein.

One or more embodiments of the invention may be implemented using instructions executed by one or more processors of the data management device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A data storage for storing client data, comprising:
a persistent storage that stores a deduplicated client data repository; and
a storage manager programmed to:
generate a time series of the deduplicated client data repository;
predict a future available storage capacity of the deduplicated client data repository using a two factor higher order fuzzy time forecasting module, and the time series;
make a determination that a storage failure of the deduplicated client data repository will occur based on the future available storage capacity; and
perform a remediation of the storage failure in response to the determination.

2. The data storage of claim 1, wherein the time series is a two-variable time series.

3. The data storage of claim 2, wherein a variable of the two-variable time series is a storage capacity of the deduplicated client data repository.

4. The data storage of claim 2, wherein a variable of the two-variable time series is a deduplication ratio of the deduplicated client data repository.

5. The data storage of claim 4, wherein the deduplication ratio is a ratio of a size of the client data received by the data storage divided by a size of the client data after being deduplicated against client data already stored in the deduplicated client data repository.

6. The data storage of claim 1, wherein performing the remediation of the storage failure comprises:
increasing a rate of garbage collection of the deduplicated client data repository.

7. The data storage of claim 6, wherein performing the remediation of the storage failure comprises:
making a second determination that the storage failure will occur based on the increased rate of garbage collection; and
in response to the second determination, orchestrating an increase in a quantity of storage allocated to the deduplicated client data repository.

8. A method for managing client data stored in a deduplicated client data repository, comprising:
generating a time series of the deduplicated client data repository;
predicting a future available storage capacity of the deduplicated client data repository using a two factor higher order fuzzy time forecasting module, and the time series;
making a determination that a storage failure of the deduplicated client data repository will occur based on the future available storage capacity; and
performing a remediation of the storage failure in response to the determination.

9. The method of claim 8, wherein the time series is a two-variable time series.

10. The method of claim 9, wherein a first variable of the two-variable time series is a storage capacity of the deduplicated client data repository.

11. The method of claim 9, wherein a first variable of the two-variable time series is a deduplication ratio of the deduplicated client data repository.

12. The method of claim 11, wherein the deduplication ratio is a ratio of a size of the client data for storage in the deduplicated client data repository divided by a size of the client data after being deduplicated against client data already stored in the deduplicated client data repository.

13. The method of claim 8, wherein performing the remediation of the storage failure comprises:
increasing a rate of garbage collection of the deduplicated client data repository.

14. The method of claim 13, wherein performing the remediation of the storage failure comprises:
making a second determination that the storage failure will occur based on the increased rate of garbage collection; and
in response to the second determination, orchestrating an increase in a quantity of storage allocated to the deduplicated client data repository.

15. A non-transitory computer readable medium comprising computer readable program code, which when executed by a computer processor enables the computer processor to perform a method for managing client data stored in a deduplicated client data repository, the method comprising:
generating a time series of the deduplicated client data repository;
predicting a future available storage capacity of the deduplicated client data repository using a two factor higher order fuzzy time forecasting module, and the time series;
making a determination that a storage failure of the deduplicated client data repository will occur based on the future available storage capacity; and
performing a remediation of the storage failure in response to the determination.

16. The non-transitory computer readable medium of claim 15, wherein the time series is a two-variable time series.

17. The non-transitory computer readable medium of claim 16, wherein a first variable of the two-variable time series is a storage capacity of the deduplicated client data repository.

18. The non-transitory computer readable medium of claim 16, wherein a first variable of the two-variable time series is a deduplication ratio of the deduplicated client data repository.

19. The non-transitory computer readable medium of claim 18, wherein the deduplication ratio is a ratio of a size of the client data for storage in the deduplicated client data repository divided by a size of the client data after being deduplicated against client data already stored in the deduplicated client data repository.

20. The non-transitory computer readable medium of claim 15, wherein performing the remediation of the storage failure comprises:
increasing a rate of garbage collection of the deduplicated client data repository.
